(19) United States
(12) Patent Application Publication
(10) Pub. No.: US 2007/0283387 A1
(43) Pub. Date: Dec. 6, 2007

(54) Reflector and method for improving transmission speed of video data in a WAN-based data collector-server architecture by the same

(76) Inventor: Sung-Feng Hsiao, Taipei County (TW)

Correspondence Address: SUNG-FENG HSIAO, P.O. Box 44-2049, Taipei, 10668, omitted

(21) Appl. No.: 11/806,691

(22) Filed: Jun. 4, 2007

(30) Foreign Application Priority Data
Jun. 5, 2006 (TW) 095119806

(51) Int. Cl. H04N 7/173; G06F 13/00; H04N 7/10; H04N 5/445; H04N 7/025; G06F 3/00

(52) U.S. Cl. 725/34; 725/42; 725/90

(57) ABSTRACT

A reflector and a method for improving transmission speed of video data in WAN-based data collector-server architecture are disclosed. The reflector includes a recorder for storing raw video data transmitted from the data collector, a program for trans code the raw video data into a predetermined format, and storage for storing the trans code video data. Meanwhile, the method includes the following steps: providing a plurality of the above-mentioned reflectors at the server, building a plurality of tunnels for transmitting the raw video data between the data collector and the server, transmitting the raw video data from the data collector to the server via the tunnels, storing the raw video data in the recorder at any given time, and reflecting the raw video data in the recorder from one reflector to any other reflectors at any given time. The method further includes the following steps: trans code the raw video data into a predetermined format by the trans code trans code program, storing the trans code video data in the storage, and deleting the trans code video data right after it has been stored in the storage.

### BACKGROUND OF THE INVENTION

1. Field of the Invention

The invention relates to an improvement of transmission speed of video data in wide area network (WAN) based data collector-server architecture, and more particularly to a reflector and a method that uses tunnels to improve the transmission speed of video data in such architecture.

2. Description of the Prior Art

In conventional data collector-server architecture, the data collector is provided with digital video recorders (DVRs) and video servers, while the server is provided with streaming servers, and thus video data is transmitted via local area network (LAN). Thereafter, the video data will be accessed a computer provided at the server and then the video data will be stored in a hard disk drive through the process of the streaming servers. Obviously, the streaming servers are extremely busy since they are supposed to be responsible for relay, storage etc. except for data streaming. Without a doubt, the streaming sever becomes the main bottle neck for the “jam”.

Nowadays, WAN is gradually replacing LAN since it allows the users to carry their receivers freely, meeting the requirements of most people, and thus becomes more and more popular.

However, when video data presented according to Real-Time Protocol (RTP) is transmitted in WAN, it will be easily lost due to the “collision” with other data. Therefore, the transmission speed of the video data is slow and the quality of video viewed from a streaming server is bad.

Additionally, the security is also an important issue during the transmission of video data in WAN because of the “collision”.

Therefore, the present invention is proposed to solve the above problems.

### SUMMARY OF THE INVENTION

The first object of the present invention is to improve the transmission speed in WAN-based data collector-serve architecture. To this end, a reflector adapted to improve the transmission speed of video data in such architecture is utilized. Meanwhile, a method for improving the transmission speed of video data in such architecture by utilizing the reflector is proposed.

The second object of the invention is to secure the video data transmitted in WAN-based data collector-serve architecture during transmission. To this end, a plurality of tunnels for exclusively transmitting the video data is built between the data collector and the server.

According to the first aspect of the present invention, a plurality of reflectors is utilized to relieve the “jam” cause by the transmission of video data in WAN. The reflector makes the simultaneous backup of video data in the above architecture possible.

According to the second aspect of the present invention, a plurality of “tunnels” is built up to secure video data transmitted in WAN. Since the transport layer is formed inside the tunnels in the network layer, all the video data transmitted from the client to the server can be secured by the tunnels. Consequently, the integrity of video data as well as the efficiency of transmission is significantly improved.

Other objects, functions and advantages of the invention will become more apparent from the following detailed description of the preferred embodiments.

### BRIEF DESCRIPTION OF THE DRAWINGS

FIG. 1 is a block diagram showing a structure of a reflector utilized in the present invention;

FIG. 2 is a block diagram showing WAN-based data collector-server architecture according to a preferred embodiment of the present invention; and

FIG. 3 is an illustration showing the preferred embodiment shown in FIG. 2 applied to a various geographic areas.

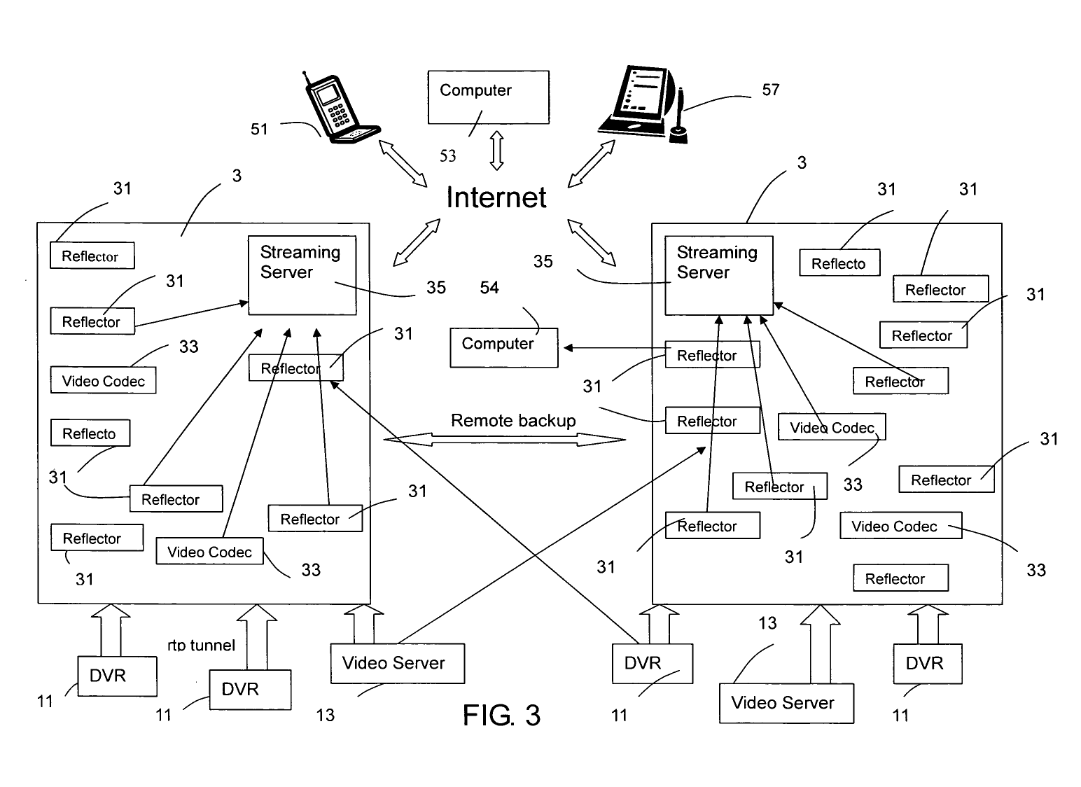

### DETAILED DESCRIPTION OF THE PREFERRED EMBODIMENT

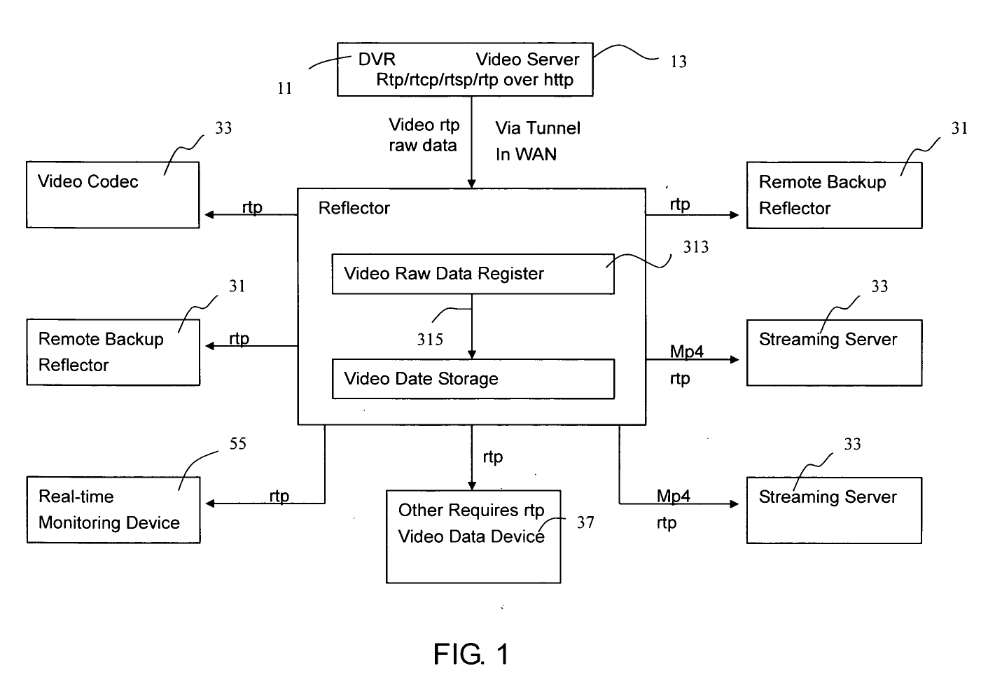

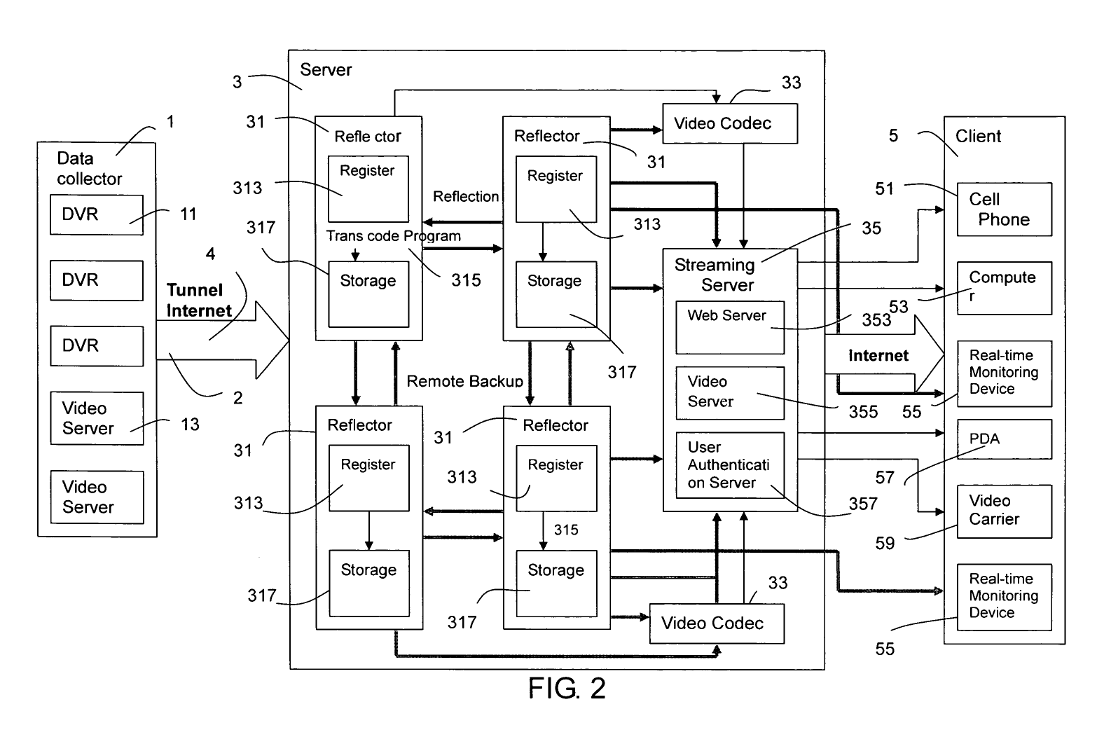

With reference to FIG. 1 and FIG. 2, a reflector 31 substantially includes a recorder 333, a trans code program 335 and storage 337. The recorder 331 is used to temporarily store the video data presented according to RTP outputted from the DVRs 11 and/or video servers 12 at the data collector 1. The trans code program 335 is used to compress the raw video data temporarily stored in the recorder 333 and trans code the compressed video data into mp4 format after every predetermined period. As to the storage 337, it could be a hard disk drive, a network attached storage, a storage area network or something like that.

The reflector 31 can not only reflect the video data from the data collector 1 to any other reflector 31, but also reflect trans code video data temporarily stored in the recorder 333 to the storage 337, video codec 33, real-time players 55, streaming servers 35 and/or any other devices 37 requiring the above video data.

As mentioned above, streaming servers are extremely busy dealing with data streaming. Referring to FIG. 2, a streaming server 35 substantially includes a web server 353, video server 355 and a user authentication server 357.

The web server 353 is responsible for providing a user's interface for both the data collector 1 that includes DVRs 11 and video server 13 etc. as well as the data collector 3 that includes computers 53, video carriers 59, the third generation (3G) cell phones 51 etc. As to the video server 355, it is responsible for the transmission of the video data streams and the management of the video data streams.

With reference to FIG. 1, the reflector 31 can shorten the latency of video data caused by the process of the streaming server 35 and therefore relieve the load of the streaming server 35 since it can reflect the video data to several devices inside/outside the server 3.

The reflectors 31 can be provided as many as we desire, and scatter anywhere we want. Each reflector 31 can share the video data with any other one and process the video data at any given time due to its functions of storage, reflection and remote backup. Since the reflector 31 can relieve a part of the load of the streaming server 35, the numbers of both required streaming servers 35 and the uses of Internet protocols (IPs) can be significantly decreased. Therefore, one of advantages of the present invention is that the cost for setting up the server 3 is lowered.

With reference to FIG. 2, an exemplary WAN-based architecture substantially includes a data collector 1, a server 2 and a client 3.

The data collector 1 is provided with several digital video recorders (DVRs) 11 and several video servers 13.

According to Open System Interconnection (OSI) seven layer model, there are totally 7 layers: application layer, presentation layer, session layer, transport layer, network layer, data link layer, and physical layer.

In this embodiment, a plurality of “tunnels” is built up to secure video data transmitted in WAN. Since the transport layer is formed inside the tunnels in the network layer, all the video data transmitted from the client 1 to the server 3 can be secured by the tunnels. Each DVR 11 and video sever 13 can transmit video data to each reflector 31 via the “tunnels” as constructed as mentioned above in WAN, and both video data and the tunnels are presented according to RTP.

The server 3 is provided with a plurality of reflectors 31, several video codec 33 and at least one streaming server 35, and the reflectors 31 are positioned prior to the streaming server 35.

The reflector 31 is a device which constantly provides multiple unicast streams to replace multicast streams to simulate an access grid node environment as a bridge for streams of video data. The reflector 31 is also a device which transmits the video data on a mirroring basis. Most important of all, the reflector 31 is programmed to simultaneously reflect the received video data to several receivers such as video codec 33, streaming servers 35, any other reflectors 31, and even the real-time monitoring devices 54 provided at the client 5. The trans code program 335 is used to compress the raw video data temporarily stored in the recorder 333 and trans code the compressed video data into mp4 format after every predetermined period.

According to the method of the present invention, the reflector 31 stores the raw video data transmitted via the tunnels into the recorders 313 thereof, compresses the raw video data temporarily stored in the recorder 333 and trans code the compressed video data into mp4 format after every predetermined period by an trans code program 315, stores the trans code data into storage 317, and deletes the trans code data from the storage 317.

The transmission of the raw video data from the data collector 1 to the reflector 31 and the transmission of the trans code video data from the reflector 31 to the video codec 33, streaming server 35 and real-time monitoring device 55 almost happen at the same time. Therefore, the time and load for the streaming server 35 to deal with the video data can be saved, and the streaming server 35 can focus on the communication with the web server 351 and the user authentication server 355.

The streaming server 35 is simply responsible for user authentication and normally remains idle. In other words, the streaming server 35 will turn on a port or a relay (not shown) to access the video data only when it approves the request launched by the user; otherwise it ignores the video data for the most of the time. Consequently, the needs for using the Internet protocols (IPs) become less, and the free space for the load of the streaming server 35 is enormously increased.

More specific, each reflector 31 can reflect video data to any other reflectors 31 to relieve the load of each streaming server 35 positioned at server 3, balancing the load sharing among the streaming servers 35.

An application of this embodiment is also proposed in the present invention. In this application, at least one reflector 31 is provided at a server 3 positioned in various geographic areas. If any one of servers 3 is damaged due to a disaster or has been stolen, the data stored therein can still be safe due to the backup made by any remote reflectors 31. Without a doubt, this is a tremendously important issue in the highly competitive IT era.

The reference numerals 31, 35 respectively refer to a plurality of streaming servers and a plurality of reflectors, instead of a single streaming server and a single reflector.

As described above, the reflector 31 is utilized to reflect video data for remote backup. Once one of the streaming servers 35 tends to be heavily loaded, the reflector 31 will assign some of the load to a streaming server 35 with a lighter load. Thus, the load sharing between/among streaming servers 35 can be balanced. Additionally, the remote backup can save the video data from being damaged by disasters.

The description and drawings are only for illustrating preferred embodiment of the present invention, and not for giving any limitation to the scope of the present invention. It will be apparent to those skilled in this art that various modifications or changes without departing from the spirit, scope and characteristic of this invention shall also fall within the scope of the appended claims of the present invention.

I claim:

1. A reflector adapted to improve transmission speed of video data in a wide area network based data collector-server architecture, the reflector comprising:
a recorder for storing raw video data transmitted from the client;
a program for trans code the raw video data into a predetermined format; and
storage for storing the trans code video data.

2. The reflector according to claim 1, wherein the raw video data is presented according to Real-Time Protocol.

3. The reflector according to claim 1, wherein the predetermined format is mp4.

4. The reflector according to claim 1, wherein the storage is selected from a group consisting of a hard disk drive, a network attached storage, and a storage area network.

5. A method for improving transmission speed of video data in a wide area network data collector-server architecture wherein the client is provided with video servers and the server is provided with streaming servers, the method comprising the following steps:
S1) providing a plurality of reflectors as defined in claim 1 at the server;
S2) building a plurality of tunnels for transmitting raw video data between the data collector and the server;
S3) transmitting the raw video data from the client to the server via the tunnels;
S4) storing the raw video data in the recorder at any given time; and
S5) reflecting the raw video data in the recorder from one reflector to any other reflectors at any given time.

6. The method according to claim 5, further comprising:
S6) trans code the raw video data into a predetermined format by the trans code program;
S7) storing the trans code video data in the storage; and
S8) deleting the trans code video data right after it has been stored in the storage.

7. The method according to claim 5, wherein the tunnels are built according to Real-Time Protocol.

8. The method according to claim 5, wherein the predetermined format is mp4.

9. A method for improving transmission speed of video data in a wide area network data collector-server architecture wherein the data collector is provided with video servers and at least one server provided with streaming servers is positioned in various geographic areas, the method comprising the following steps:
S1) providing a plurality of reflectors as defined in claim 1 at each of the servers;
S2) building a plurality of tunnels for transmitting raw video data between the data collector and the server;
S3) transmitting the raw video data from the data collector to the server via the tunnels;
S4) storing the raw video data in the recorder at any given time; and
S5) reflecting the raw video data in the recorder from one reflector to any other reflectors at any given time.

10. The method according to claim 9, further comprising:
S6) trans code the raw video data into a predetermined format by the trans code program;
S7) storing the trans code video data in the storage; and
S8) deleting the trans code video data right after it has been stored in the storage.

11. The method according to claim 9, wherein the tunnels are built according to Real-Time Protocol.

12. The method according to claim 9, wherein the predetermined format is mp4.
